(19) United States
(12) Patent Application Publication
(10) Pub. No.: US 2007/0096896 A1
(43) Pub. Date: May 3, 2007

(54) System and method for securing an infrastructure

(76) Inventors: Virginia Ann Zingelewicz, Scotia, NY (US); Helena Goldfarb, Niskayuna, NY (US); Corey Nicholas Bufi, Troy, NY (US); Steven Hector Azzaro, Schenectady, NY (US); Jeffrey Scott Thetford, Cypress, TX (US)

Correspondence Address: Patrick S. Yoder;FLETCHER YODER, P.O. Box 692289, Houston, TX, 77269-2289, US

(21) Appl. No.: 11/260,897

(22) Filed: Oct. 28, 2005

(51) Int. Cl. G08B 19/00

(52) U.S. Cl. 340/522

(57) ABSTRACT

A system for detecting potentially adverse conditions includes a plurality of different types of sensors each adapted to monitor a different measured parameter of an infrastructure. The system also includes a model that fuses data from the plurality of sensors and provides an indication of a potentially adverse condition. A method is also provided for detecting potentially adverse conditions.

### BACKGROUND

The present invention relates generally to a method and system for securing an infrastructure such as a pipeline. More particularly, the present invention relates to a method and system for implementing sensor arrangements and gathering data to protect the infrastructure against potential threats.

In recent years, considerable efforts have been made to secure infrastructures such as pipelines and associated oil and gas infrastructures, with support from both industry and government. Other examples of infrastructures include rail lines, waterways, electrical distribution networks, water distribution networks, and so forth. Securing infrastructures against intentional destructive attacks has been an important focus. However, infrastructures also face threats of accidental damage, for example, such as damage from farmers plowing fields with large machinery, or from backhoes and other machinery used in construction or excavation activities. Providing protection for infrastructures is a complicated task because many are extremely large and easily accessible.

Traditionally, responses to threats against such infrastructures have been mostly reactive, mainly because of the enormous amount of resources required to safeguard such infrastructure sites. Ground and aerial patrols have been used, but such patrols have limitations of timely preparedness for responding to a threat effectively. In-person patrolling is not a cost-effective solution, especially where continuous monitoring is considered desirable. Additionally, daily patrolling of pipeline resources has been estimated to be relatively ineffective in terms of actual damage prevention.

Some recent developments in automated pipeline security include the use of acoustic monitoring, geophones, fiber optic cables, satellite surveillance and the like. These solutions have several limitations. One problem has proven to be a high occurrence of false positive alarms. A false positive is an indication of an imminent threat when, in fact, no such imminent threat exists. Additionally, monitoring techniques such as acoustic sensing and geophone technology do not necessarily provide an ability to actually prevent damage after a threat is detected. Geophones and fiber optic cables need to be physically placed in the right of way (ROW) of a monitored infrastructure, thus increasing vulnerability and concomitant monitoring costs. Satellite surveillance is expensive and is not feasible as a sole method for real time threat detection.

Therefore, there is a need for an improved system and method for detecting threats for large infrastructures such as pipelines. Such a system may provide proactive threat warnings with a reduced occurrence of false positive alarms.

### BRIEF DESCRIPTION

Briefly, in accordance with one embodiment of the invention, a system is provided for detecting potentially adverse conditions of the environment in and around the infrastructure. The system includes a plurality of sensors, each adapted to monitor a different measured parameter of an infrastructure or its surrounding environment. The system also includes a model that fuses data from the plurality of sensors and provides an indication of a potentially adverse condition.

In accordance with another embodiment of the invention, a method is provided for detecting potentially adverse conditions of the environment in and around the infrastructure. The method includes identifying a potentially adverse condition relative to an infrastructure or its surrounding environment. The method also includes selecting a plurality of sensors, each of the plurality of sensors being adapted to monitor a different measured parameter indicative of the potentially adverse condition. The method further includes designing a model that fuses data from the plurality of sensors to produce an indication corresponding to a probability that the potentially adverse condition will appear.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic representation of a security monitoring system for a pipeline infrastructure according to one embodiment of the invention;

FIG. 2 is a diagrammatic representation of multiple exemplary protected zones of the infrastructure of FIG. 1, with a centralized network of sensors according to one embodiment of the invention;

FIG. 3 is a diagrammatic representation of multiple exemplary protected zones of the infrastructure of FIG. 1, with a decentralized network of sensors according to one embodiment of the invention; and

FIG. 4 is a flow chart illustrating exemplary method steps for securing a pipeline infrastructure according to one embodiment of the invention.

### DETAILED DESCRIPTION

The present technique relates to the use of combinations of multiple sensors of different types to provide an early indication of a potential threat to an infrastructure or other monitored location. A profile of potential threats and the expected parameters that would be generated for each of the chosen sensor types is developed for comparison with input data. It is believed that profiles that account for more than one type of sensor are more reliable for detection of potential threat conditions because it is less likely that something other than a potential threat would produce a sensor stimulus in an expected range for multiple sensors that are adapted to sense different types of data. Embodiments of the present technique relate to the selection of sensor combinations and development of modeling criteria to improve detection of potential threat conditions while reducing the occurrence of false positive alarms.

Combinations of sensors may be chosen for a given environment, infrastructure or known threat behavior. Examples of sensors from which combinations may be selected include, without limitation, magnetometers, accelerometers, range controlled radars, microphones, gas sensors or the like. Sensors may be used to detect and measure the trajectory and behavioral patterns of various threat causing agencies such as individual persons or vehicles within or near a protected zone. As set forth below, the sensor types chosen for different portions of a protected zone may be chosen because of the effectiveness of the chosen combination at detecting a specific potential threat that is more likely to be present in the specific area of the protected zone.

The use of combinations of multiple types of sensors tends to reduce occurrences of false positives. A false positive is an indication of an imminent threat when, in fact, no such imminent threat exists. The use of combinations of multiple types of sensors allows the development of a profile based on input data from multiple types of sensors instead of a single sensor. Thus, an intrusion may be identified as a potential threat if all or many of the multiple types of sensors' inputs provide an indication that corresponds to the profile of that potential threat.

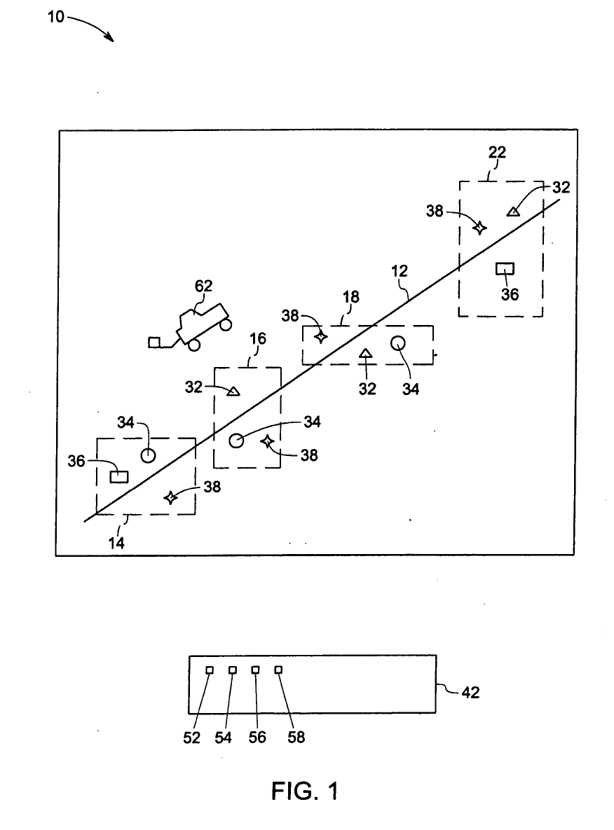

By way of example, FIG. 1 illustrates a security monitoring system 10 for an infrastructure, that includes, for instance, a pipeline 12, which runs across several miles. The region around the pipeline 12 that needs protection can be divided into distinct protected zones, as illustrated by reference numerals 14, 16, 18 and 22. The choice of these protected zones 14, 16, 18 and 22 depends on design considerations such as a choice of communication network, or the actual geography of the landscape where the infrastructure to be protected is located. The choice may also depend on sensitivity of a particular area to threat as will be explained later. Combinations of different sensor types may advantageously be used to detect various parameters and gather more information about a potential threat level.

An exemplary combination of sensors dispersed around these protected zones 14, 16, 18 and 22 may include a plurality of sensors 32, 34, 36 and 38, single or multiple instance of which are chosen to detect a threat activity, even prior to actual threat or damage to the infrastructure. Each of the sensors 32, 34, 36 and 38 is configured to detect a threat behavior of a typical threat causing agency corresponding to an outcome that causes damage to the infrastructure and send a signal representing the threat behavior. By way of example, the sensor 32 may comprise one or more magnetometers and the sensor 34 may comprise one or more accelerometers. The sensor 36 may comprise a range controlled radar and the sensor 38 may comprise one or more microphones. By developing a profile indicative of an expected input from each of these sensors for a particular potential threat, early threat detection capabilities are improved and occurrences of false positive indications of potential threats are reduced.

The range of a typical sensor 32 or 34 or 36 or 38 may not however be limited to one particular protected zone 14 or 16 or 18 or 22. In one embodiment of the invention, one or more of the sensors 32, 34, 36 and 38 may have a range larger than its corresponding protected zone 14, 16, 18 or 22.

The plurality of sensors 32, 34, 36, 38 may form a network for wirelessly communicating with each other. In another embodiment of the invention, the sensors 32, 34, 36, 38 may communicate wirelessly with each other in a pre-defined fashion. In yet another embodiment of the invention, the output of several types of sensors may be combined and/or several sensors may be arranged such that the output of one is input to another. In yet another embodiment of the invention, typical sensor packages may use additional information, with probabilistic logic, to determine one or more attributes about the corresponding protected zone that may indicate a threat level. Moreover, the installations of the multiple types of sensors 32, 34, 36, 38 may be permanent in one embodiment of the invention such that these, once installed, remain in the high probability area. In another embodiment of the invention, for instance, at a construction site the installations of the sensors 32, 34, 36, 38 may be temporary.

As set forth above, one of the plurality of sensors 32, 34, 36 and 38 may comprise a magnetometer. As will be appreciated by those skilled in the art, magnetometers are sensors that measure changes in the earth's magnetic field. In case of threat to any infrastructure and more specifically to pipelines, the threat could involve the use of a moving metal object, for example, a backhoe, or any other similar object, which can be detected by the magnetometers.

A range controlled radar may be employed as a sensor to detect a potential threat entering and moving about in the safe zone. The distance to the same threat causing agency may be calculated from the time the signal takes to travel to and from the threat causing agency. Combining active radar detection method with passive infrared sensing, a typical range-controlled radar system may provide enhanced detection of moving objects and reduced false positive alarm frequency within a range selected.

In one exemplary embodiment of the invention, an in-field supervisory control center 42 may be installed to receive, process and coordinate the sensing signals from various types of sensors 32, 34, 36 and 38. Additionally, it may transmit this data to a remote monitoring center that further analyzes the information and generates alerts. Structurally, the in-field supervisory control center 42 may include one or more micro-controllers and one or more solid-state switches configured to communicate with the multiple types of sensors 32, 34, 36 and 38 in various electrical communication modes. In another embodiment of the invention, the in-field supervisory control center 42 may include logic for activating a number of alert signals in coordination with the multiple types of sensors 32, 34, 36 and 38. An example of this embodiment might be a construction site where the alert would be generated locally in the form of a flashing light or siren sounding when a backhoe approached a pipeline. In a further embodiment, these alerts signals and the data received by the in-field supervisory control center are transmitted to a remote monitoring center for further processing, logging, and alert generation.

Logical processing inputs from the multiple types of sensors may include the use of multiple types of hybrid fusion models 52, 54, 56, 58 for determining a threat level if anything comes in the proximity of the infrastructure 12. The output of the sensors 32, 34, 36 and 38 may be evaluated by the multiple types of hybrid fusion models 52, 54, 56 and 58 to determine whether there is any increase in the threat level and thereby ascertain any serious imminent danger. Each of the multiple types of hybrid fusion models 52, 54, 56, 58, receives the signals from one or more of the multiple types of sensors 32, 34, 36 and 38 and fuses these differing signals. In one embodiment of the invention, one or more of the multiple types of hybrid fusion models 52, 54, 56 and 58 may be positioned inside a protected zone.

A typical hybrid fusion model 52 or 54 or 56 or 58, as described above, may sense and determine whether a threat level associated with the behavior of a threat causing agency is normal or not. The hybrid fusion models 52, 54, 56 or 58 may rely on the inputs of multiple types of sensors because combinations of inputs from different types of sensors may be indicative of particular threat behaviors. For instance, a disturbance measured by a magnetometer in combination with sound in a particular frequency range may be indicative of the presence of a backhoe in a protected zone. This way, the hybrid fusion models 52, 54, 56, 58 process the signals coming from the multiple types of sensors 32, 34, 36 and 38 by fusing them to determine a likelihood of the outcome and provide a signal indicative of the same likelihood of the outcome with low false positives. Multiple types of hybrid fusion models and their application and characteristic behavior in relation to threat level sensing will be explained later in more detail.

Normalcy of a threat level may be typically interpreted in one embodiment of the invention as being within an anticipated range of the detection parameter of the sensor. If any sensor senses and determines that the threat level is not normal, an alert may be relayed to an in-field supervisory control center, or a remote monitoring center via an in-field supervisory control center in accordance with an exemplary embodiment. The magnetometers, accelerometers, range controlled radars or any similar sensor deployed in a typical security monitoring system 10 in accordance with various embodiments of this invention may thus be designed to collect, process and communicate critical information in a reliable and robust fashion. It will be appreciated by those skilled in the art, that the alert signal is relayed in real-time and thus facilitates preventive action to avoid any outcome that causes damage.

The operation of an exemplary embodiment of the present invention is described below using a backhoe as an example of threat causing agency 62. It should be understood that the invention may be employed to detect a wide range of threat causing agencies, depending on the design and environment of the protected infrastructure.

Examples of various threat causing agencies may be human errors, human interferences (unintentional as well as intentional) and natural hazards. Natural hazards may include hazards caused by geological forces such as earthquakes, landslides or the like. In one embodiment of the invention, multiple types of sensors and multiple types of hybrid fusion models are described that work together to detect the preliminary signs of an outcome that causes damage before the event actually occurs. These preliminary signs provide responsible authorities reasonable time to respond and prevent the damage to the infrastructure, or at least reduce the overall amount of damage done. For instance, an accident may be avoided by reducing the pressure in a gas pipeline that is about to experience third party damage. In another embodiment of the invention, the operational logic of the security monitoring system 10 synergistically combines the use of the multiple types of sensors 32, 34, 36 and 38 and the multiple types of hybrid fusion models 52, 54, 56 and 58 to collate the sensor data and effectively construct a complete picture of imminent danger. Combined, these multiple types of sensors 32, 34, 36 and 38 and the multiple types of hybrid fusion models 52, 54, 56 and 58 may produce a high-accuracy, low false-positive identification of potential threats. That in turn allows the protected zones identified to be effectively monitored using that method.

In one embodiment of the invention, the threat behavior data relating to a typical threat causing agency 62 may include a threat behavior before the threat causing agency 62 enters a protected zone 14 or 16 or 18 or 22. In another embodiment of the invention, the threat behavior data may include threat behavior while the threat causing agency 62 is inside a protected zone 14 or 16 or 18 or 22. In yet another embodiment of the invention, the threat behavior data may include data related to location and action of the threat causing agency with respect to spatial boundaries and proximity to the infrastructure when the threat causing agency 62 is inside the protected zone 14 or 16 or 18 or 22.

A typical potential threat level as interpreted by the multiple types of hybrid fusion models 52, 54, 56 and 58 may be based on a real-time snapshot of the activities in and around a protected zone 14 or 16 or 18 or 22. In one embodiment of the invention, data from the multiple types of hybrid fusion models 52, 54, 56 and 58 at the in-field supervisory center or at the remote monitoring center may indicate whether a threat level is below a determined threshold for providing an alert. In another embodiment of the invention, the multiple types of hybrid fusion models 52, 54, 56 and 58 at the in-field supervisory center or at the remote monitoring center 42 may determine whether the threat level is above a determined threshold for providing an alert.

In one embodiment of the invention, one or more of the exemplary multiple types of hybrid fusion models 52, 54, 56 and 58 may be Markov model(s). A Markov model is a collection of finite set of states, each of which is associated with a probability distribution. The probability distributions may typically be multidimensional and transitions among the states are governed by a set of probabilities called transition probabilities. Markov models typically serve to detect signals from the multiple types of sensors 32, 34, 36 and 38 before any threat causing agency even enters the protected zone. In one embodiment of the invention, one or more of the multiple types of sensors 32, 34, 36 and 38, such as accelerometers and the microphones if used, may have a range larger than its corresponding protected zone 14, 16, 18 or 22 and the Markov models tend to be very useful in such applications.

In another embodiment of the invention, one or more of the exemplary multiple types of hybrid fusion models 52, 54, 56 and 58 may use Bayesian Belief Networks. As is well understood in the art, Bayesian Belief Networks are used to typically define various events, the dependencies between them, and the conditional probabilities involved in those dependencies. Applying the technique in one embodiment of this invention, an identification process of an object moving in and around a protected zone and its physical dimensions may be determined. For instance, using a Bayesian Belief Network a probability of likelihood that a moving object is of a predetermined particular type and/or its physical dimensions are that of a predetermined particular object may be determined with certain degree of confidence. In operation, once the object has reached the protected zone, all of the sensors within the protected zone come into play. They all transmit their signals to the Bayesian Belief Network model. These models then fuse the inputs and deduce, with a high degree of certainty, what the threat causing agency may be and what may be the level of threat associated.

In yet another embodiment of the invention, one or more of the exemplary multiple types of hybrid fusion models 52, 54, 56 and 58 may be spatial models. In operation, spatial models typically receive signals once a threat causing agency is within a protected zone. Spatial models process the signals coming from various sensors 32, 34, 36 and 38 and help interpret various movements of the threat causing agency. In one instance the spatial models may determine whether the threat causing agency is near an infrastructure that is to be protected. In another instance, the spatial models may determine whether the threat causing agency is moving quickly or stopping near the asset to be protected. An exemplary situation of appropriate threat level detection may be when a threat causing agency, such as a backhoe is sensed to move towards a specific pipeline. In one such situation, a non-threatening behavior of the backhoe may be one when the backhoe moves at a constant speed through the protected zone. On the other hand, detecting that the backhoe is stopping near the pipeline may indicate it is preparing to dig and is thus a threat. The role and the applications of the spatial models in this particular situation are of special significance. Both Markov models and Bayesian Belief Network models in one such situation may tend to deduce that the threat associated with the movement of the backhoe is high. The spatial models however contribute to the critical decision that the backhoe is moving fast enough to pass the pipeline by safely and so the threat level associated is low and thus there is no need to alert a pipeline operator.

In one embodiment of the invention, one or more of the Markov models typically starts the deduction process whenever there is a threat causing agency in the vicinity of a protected zone. As a threat causing agency moves about and it reaches the protected zone, the Bayesian Belief Network and the spatial models then begin processing. Outputs of all three of these fusion models are then fused to reach a final decision. Moreover, the use of multiple types of sensors and multiple fusion models tends to provide a low occurrence of false positive alerts. Alternatively, one single hybrid fusion model may be used to fuse the sensor outputs depending on the specific application at hand. In another embodiment of the invention, the multiple types of hybrid fusion models may be installed in one or more protected zones. Whatever be the deployment mode, the multiple types of hybrid fusion models 52, 54, 56 and 58 may be adapted to make decisions in coordination with the multiple types of sensors 32, 34, 36 and 38.

In operation, the security monitoring system 10 synergistically combines two different aspects of infrastructure damage prevention. First, a ‘multiple types of sensor’ approach to detect potential threats to an infrastructure and second, associating a hybrid fusion modeling system to fuse the sensor inputs and determine the threat level with low numbers of false positives. The multiple types of sensors 32, 34, 36 and 38 may be selected based on the typical threat behaviors experienced in and around a protected zone. For example, for a typical pipeline industry, a major source of damage may be accidents caused by backhoes hitting pipes that carry liquid or gas. A range of possible behaviors of the backhoe such as backing the backhoe off of a trailer, moving it towards the pipeline, slowing near the pipeline, lowering the support feet, lowering the bucket to dig and the like that eventually may lead up to the backhoe hitting the pipe may be distinct from one another. There may be sensors that may work together to discern and detect these behaviors and warn to the advantage of a well-coordinated maintenance of the security monitoring system 10. The use of multiple types of sensors allows various industrial zones to be protected while preventing unnecessary false positive alarms.

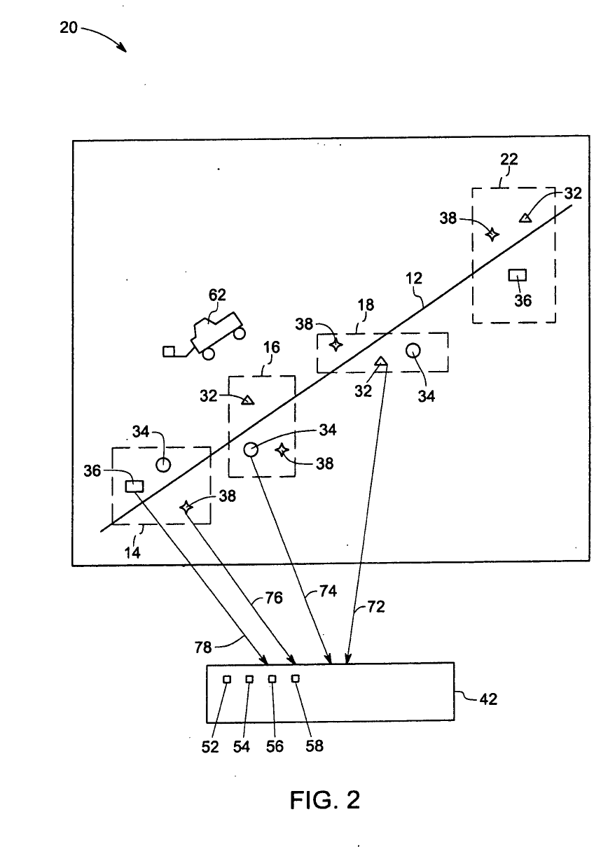

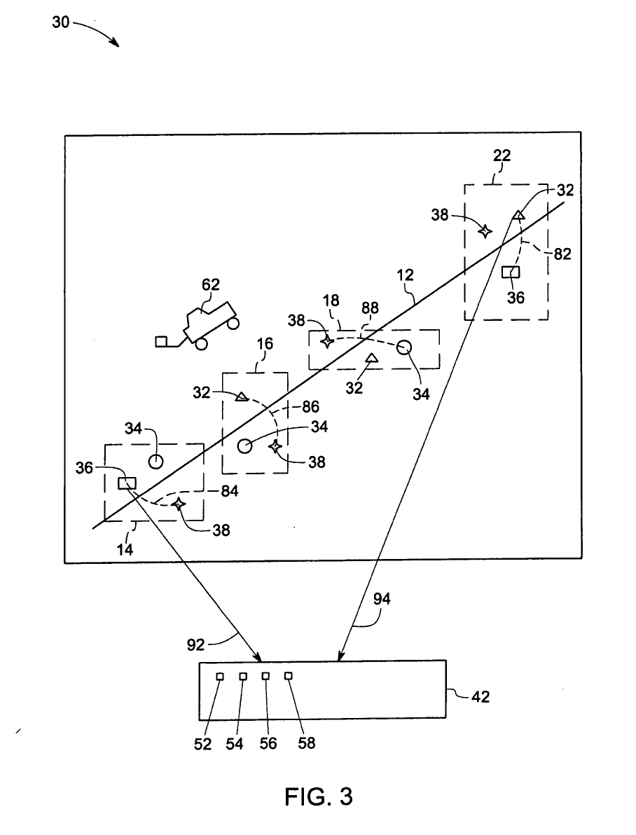

In operation, each of the multiple types of hybrid fusion models 52, 54, 56 and 58 may respond to the actions of a threat causing agency 62 in a different way, and all of them may be designed such that their collective response encodes an assessment of the level of threat being posed to the infrastructure. The sensor signals are transmitted to an in-field supervisory control center, and possibly from the in-field center to a remote monitoring center. Appropriate action may be taken at either or both of the in-field supervisory control center or the remote monitoring center. FIG. 2 and FIG. 3 illustrate all possible ways in which the sensors 32, 34, 36 and 38 may communicate. The multiple types of sensors 32, 34, 36 and 38, the associated multiple types of hybrid fusion models 52, 54, 56, and 58 may communicate with each other in a various number of communication modes. Moreover, their interaction pattern with the supervisory control center 42 may follow either a centralized manner or a decentralized manner. Each of the embodiments is described in more detail below. Centralized control, as described in FIG. 2 means that all the sensing signals from all the sensors are received, pre-processed and transmitted by the supervisory control unit 42, whereas decentralized control as described in FIG. 3 means at least two or more sensors within the same safe-zone communicate with each other. In either of the two communication modalities, the in-field supervisory control center 42 may communicate the final threat level assessment via a satellite network or may transmit the threat level and the data it received to a remote monitoring center.

FIG. 2 shows the details of the security monitoring system 20 as is explained in accordance with an exemplary embodiment of this invention. In addition to the elements described in relation to FIG. 1, the security monitoring system 20 also includes exemplary first sensing signal 72, exemplary second sensing signal 74, exemplary third sensing signal 76, exemplary fourth sensing signal 78. Components in FIG. 2 that are identical to components of FIG. 1 are identified in FIG. 2 using the same reference numerals used in FIG. 1.

The centralized control method adopted in the security monitoring system 20 of FIG. 2 indicates one of two forms of operation. In the first form, the in-field supervisory control center, 42, receives sensor data from the multiple types of sensors 32, 34, 36, 38, pre-processes the data, and transmits the data to a remote monitoring center. At the remote monitoring center, the data is further processed using hybrid fusion models, and an alarm-state or no-alarm-state decision is reached. If an alarm-state decision is reached, this alarm is transmitted from the remote monitoring center in various forms to appropriate locations. In the second form, the in-field supervisory control center, 42, receives sensor data from the multiple types of sensors 32, 34, 36, 38, pre-processes the data, runs fusion models from the multiple types of hybrid fusion models 52, 54, 56 and 58, computes feature vectors, applies modeling constraints, and assesses threat level. At that point, the in-field supervisory control center can sound a local alarm and/or transmit the log and alarm state to a remote monitoring center. In addition, the multiple types of sensors 32, 34, 36 and 38 receive various operational commands from the supervisory control center 42 to adjust their various sensing and computational load parameters such as sampling rate, state changes and the like.

FIG. 3 is a diagrammatic representation of one example of a protected zone of the large infrastructure of FIG. 1, with a decentralized network of sensors according to aspects of one embodiment of the present invention. In this decentralized network, at least two sensors within the same protected zone communicate with each other, in addition to having the sensors communicate to the in-field supervisory center. This might happen, for example, when one sensor serves to trigger behavior in another sensor. FIG. 3 shows the details of the security monitoring system 30 as is explained in accordance with an exemplary embodiment of this invention. In addition to the elements described in relation to FIG. 1, the security monitoring system 30 also includes exemplary first sensing signal 82, exemplary second sensing signal 84, exemplary third sensing signal 86, exemplary fourth sensing signal 88, exemplary fifth sensing signal 92 and exemplary sixth sensing signal 94. Components in FIG. 3 that are identical to components of FIG. 1 are identified in FIG. 3 using the same reference numerals used in FIG. 1.

The decentralized control method adopted in the security monitoring system 30 of FIG. 3 signifies that at least two or more sensors within the same safe-zone communicate with each other as well as with the supervisory control center 42. At that point, one of two actions occurs. In the first form, the in-field supervisory control center, 42, receives sensor data from the multiple types of sensors 32, 34, 36, 38, pre-processes the data, and transmits the data to a remote monitoring center. At the remote monitoring center, the data is further processed using hybrid fusion models, and an alarm-state or no-alarm-state decision is reached. If an alarm-state decision is reached, this alarm is transmitted from the remote monitoring center in various forms to appropriate locations. In the second form, the in-field supervisory control center, 42, receives sensor data from the multiple types of sensors 32, 34, 36, 38, pre-processes the data, runs fusion models from the multiple types of hybrid fusion models 52, 54, 56 and 58, computes feature vectors, applies modeling constraints, and assesses threat level. At that point, the in-field supervisory control center can sound a local alarm and/or transmit the log and alarm state to a remote monitoring center. In addition, the multiple types of sensors 32, 34, 36 and 38 receive various operational commands from the supervisory control center 42 to adjust their various sensing and computational load parameters such as sampling rate, state changes and the like.

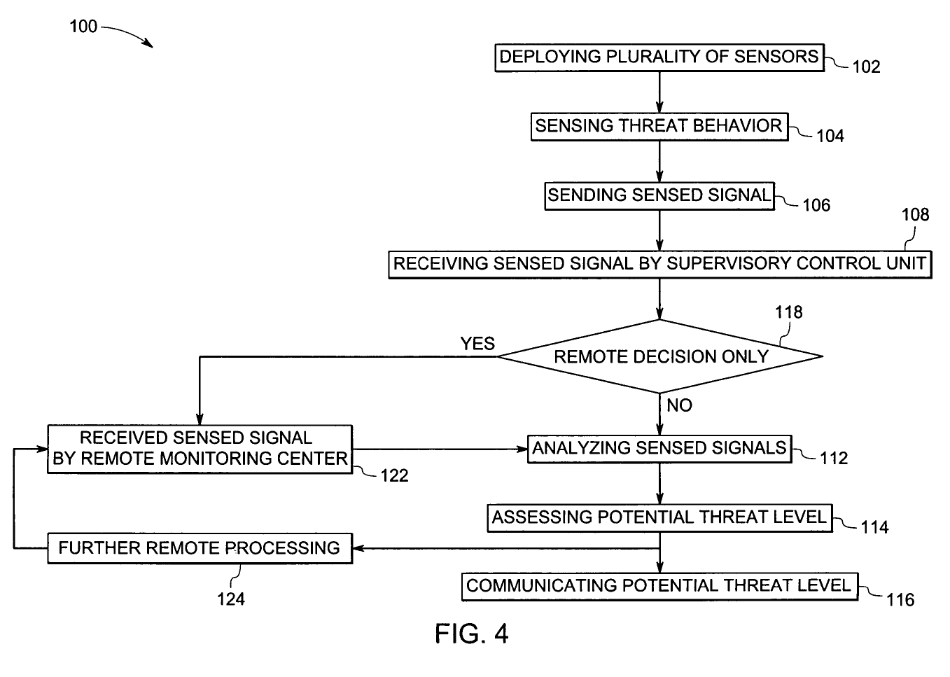

FIG. 4 is a flowchart illustrating exemplary security monitoring method 100 for securing an infrastructure as disclosed. The method includes, at step 102, deploying sensors and establishing a network around the infrastructure using multiple types of sensors such as accelerometers, magnetometers, range control radars, microphones, gas sensors or the like, as appropriate for the given application. The network is wireless. This process may also include a number of sub-processes, such as for establishment and verification of communications between the sensors, localization of the sensors, implementation of desired communications protocols, and so forth. At step 104, sensing threat behavior and an attribute about the area is sensed, for example, a magnetic flux and a change in magnetic flux profile around the infrastructure via a magnetometer. A sensed signal is generated at step 106. As noted above, the sensing of the signals via the sensors may be performed following calibration of the sensors, such as for base levels of flux at the particular location of the individual sensors. Continuing, sensor data from the multiple types of sensors 32, 34, 36, 38 are received by the in-field supervisory control center as in step 108. At that point, one of two actions occurs as is represented by the decision box 118.

In the first form, when remote decisions are not required, the in-field supervisory control center analyzes the data as in functional block 112 assessing potential threat levels as in functional block 114 for determining a threat level around the infrastructure. As noted above, the detection of potential threats to the infrastructure may include, for example, determining whether the threat level is below a threshold level for alerting or above the threshold level for alerting. Logic for such analysis may be provided in the individual sensors, or may be performed by particular, multiple types of hybrid fusion models associated with the multiple types of sensors, or by processors either in the field or at the supervisor control centers on site or at a remote location. In case the analysis shows that the threat level is above the threshold level for alerting, communicating potential threat level as in functional block 116 an alert is relayed to a central unit or other desired oversight location, as described herein above with reference to FIG. 2.

In the second form, when remote decisions are required, the sensor data from the multiple types of sensors 32, 34, 36, 38 as received by the in-field supervisory control are sent to a remote monitoring center as in step 122. At the remote monitoring center, the data is further processed using hybrid fusion models as in functional block 112 assessing potential threat levels as in functional block 114 for determining a threat level around the infrastructure. At that point, if further remote decisions are required, the analysis results are resent to the remote monitoring center for further processing and a second decision look as described as above. At the end of the analysis, finally an alarm-state or no-alarm-state decision is reached. If an alarm-state decision is reached, an alert is relayed to a central unit or other desired oversight location communicating potential threat level as in functional block 116, as described herein above with reference to FIG. 2.

Aspects of the present invention as described herein thus yield accurate sensing and reliable alerting for providing proactive reliability and proactively monitoring for any infrastructure. The coordination of the multiple sensors and multiple sensor types with the multiple types of hybrid fusion models tends to reduce false positives. The technique advantageously provides early detection of any threat activity before damage to the infrastructure occurs, and provides time for suitable preventive actions and response. Aspects of the present invention also provide a unique system for monitoring damage and providing real-time alerts using sensing and processing units and a remote alerting system. It would be well appreciated by those skilled in the art that though the description above relates to protection of a pipeline as an exemplary infrastructure, aspects of the present invention are equally applicable to other infrastructures, such as power stations, railways, airports and other infrastructures, which are generally widespread and difficult to physically monitor and secure.

While only certain features of the invention have been illustrated and described herein, many modifications and changes will occur to those skilled in the art. It is, therefore, to be understood that the appended claims are intended to cover all such modifications and changes that fall within the true spirit of the invention.

1. A monitoring system for a infrastructure, comprising:
a plurality of different types of sensors disposed around a protected zone of the infrastructure, wherein each of the plurality of sensors is configured to detect at least one threat behavior corresponding to an outcome that causes damage to the infrastructure and send a signal representing the threat behavior; and
at least one hybrid fusion model adapted to receive the signals sent by the plurality of sensors, assess the signals to determine a likelihood of an outcome that causes damage and provide a signal indicative of the likelihood of the outcome if the likelihood of the outcome exceeds a threshold.

2. The system of claim 1, wherein the at least one hybrid fusion model comprise at least one of a Markov model, a Bayesian Belief Network, and a spatial model.

3. The system of claim 2, wherein the Markov model is adapted to determine the likelihood of the outcome prior to arrival of a potential threat in the protected zone, at least one of the Bayesian Belief Network and the Spatial model is adapted to determine the likelihood of the outcome after the arrival of the potential threat in the protected zone and the Markov model, the Bayesian Belief Network, and the spatial model together determine whether the likelihood of the outcome exceeds the threshold.

4. The system of claim 1, wherein the plurality of sensors comprises at least one of an accelerometer, a magnetometer, a microphone, a gas sensor, and a range-controlled radar.

5. The system of claim 1, wherein at least one of the plurality of sensors has a range larger than the protected zone.

6. The system of claim 1, wherein the plurality of sensors comprises a network for wirelessly communicating with the at least one hybrid fusion models.

7. The system of claim 1, wherein the at least one threat behavior comprises an intrusion of at least one of a backhoe, a truck, a car, a living being and a natural hazard.

8. The system of claim 1, wherein each of the plurality of sensors is configured to communicate with each other either in a centralized manner or in a decentralized manner.

9. The system of claim 8, further comprising:
an in-field supervisory control center configured to coordinate the communication in centralized or decentralized manner, the supervisory control center comprising at least one hybrid fusion model.

10. The system of claim 9 further comprising an alerting system in communication with the in-field supervisory control center and adapted to provide an alert signal indicative of the likelihood of the outcome if the likelihood of the outcome exceeds a threshold.

11. A system for detecting potentially adverse conditions, comprising:
a plurality of different types of sensors, each adapted to monitor a different measured parameter of an infrastructure; and
at least one model that fuses data from the plurality of sensors and provides an indication of a potentially adverse condition.

12. The system of claim 11, wherein the plurality of sensors comprises at least one of an accelerometer, a gas sensor, a magnetometer, a microphone and a range controlled radar.

13. The system of claim 11, wherein the at least one model comprises at least one of a Markov model, a Bayesian Belief Network, and a spatial model.

14. The system of claim 11, wherein the indication of a potentially adverse condition comprises a threat level.

15. The system of claim 11, wherein the measured parameter corresponds to at least one of information received prior to arrival of a potential threat, after arrival of the potential threat and physical proximity of the potential threat to the infrastructure.

16. A monitoring method for an infrastructure, comprising:
deploying a plurality of different types of sensors around a protected zone of the infrastructure, wherein each of the plurality of sensors is configured to detect at least one threat behavior corresponding to an outcome that causes damage to the infrastructure;
sensing at least one threat behavior corresponding to the outcome that causes the damage to the infrastructure and sending a signal representing the threat behavior;
deploying at least one hybrid fusion model adapted to receive the signals sent by the plurality of sensors, assessing the signals to determine a likelihood of the outcome; and
providing a signal indicative of the likelihood of the outcome if the likelihood of the outcome exceeds a threshold.

17. The method of claim 16, wherein the at least one hybrid fusion model comprises at least one of a Markov model, a Bayesian Belief Network, and a spatial model.

18. The method of claim 17, wherein the Markov model is adapted to determine the likelihood of the outcome prior to arrival of a potential threat in the protected zone, at least one of the Bayesian Belief Network and the Spatial model is adapted to determine the likelihood of the outcome after the arrival of the potential threat in the protected zone and the Markov model, the Bayesian Belief Network, and the spatial model together determine whether the likelihood of the outcome exceeds the threshold.

19. The method of claim 16, wherein the plurality of sensors comprises at least one of an accelerometer, a magnetometer, a microphone, a gas sensor, and a range-controlled radar.

20. The method of claim 16, wherein at least one of the plurality of sensors has a range larger than the protected zone.

21. The method of claim 16 further comprising establishing a network for wirelessly communicating with the at least one hybrid fusion models.

22. The method of claim 16, wherein the at least one threat behavior comprises an intrusion of at least one of a backhoe, a truck, a car, a living being and a natural hazard.

23. The method of claim 16, wherein each of the plurality of sensors is configured to communicate with each other either in a centralized manner or in a decentralized manner.

24. The method of claim 23, further comprising:
disposing an in-field supervisory control center to coordinate the communication in centralized or decentralized manner, the supervisory control center comprising at least one hybrid fusion model.

25. A method of detecting potentially adverse conditions, comprising:
identifying a potentially adverse condition relative to an infrastructure;
selecting a plurality of sensors, each of the plurality of sensors being adapted to monitor a different measured parameter indicative of the potentially adverse condition; and
designing at least one model that fuses data from the plurality of sensors to produce an indication corresponding to a probability that the potentially adverse condition will appear.

26. The method of claim 25, wherein the plurality of sensors comprises at least one of an accelerometer, a gas sensor, a magnetometer, a microphone and a range controlled radar.

27. The method of claim 25, wherein the indication comprises a threat level.

28. The method of claim 25, wherein the measured parameter corresponds to at least one of information received prior to arrival of a potential threat, after arrival of the potential threat and physical proximity of the potential threat to the infrastructure.

29. The method of claim 25, wherein the plurality of sensors provide wireless data.

30. A means for detecting potentially adverse conditions, comprising:
means for identifying a potentially adverse condition relative to an infrastructure;
means for sensing and monitoring different measured parameters indicative of the potentially adverse condition; and
means for fusing data from the sensing and monitoring means to produce an indication corresponding to a probability that the potentially adverse condition will appear.
